(19) United States
(12) Patent Application Publication
(10) Pub. No.: US 2019/0333302 A1
(43) Pub. Date: Oct. 31, 2019

(54) Smart and Secure Delivery Door for Packages

(71) Applicants: Ysehak Kagnew, Edgewater, MD (US); Josiah Aklilu, Aurora, CO (US)

(72) Inventors: Ysehak Kagnew, Edgewater, MD (US); Josiah Aklilu, Aurora, CO (US)

(21) Appl. No.: 16/416,196

(22) Filed: May 18, 2019

Related U.S. Application Data
(60) Provisional application No. 62/682,141, filed on Jun. 7, 2018.

(51) Int. Cl. G07C 9/00; G06Q 10/08; G06K 7/14; H04N 7/18

(52) U.S. Cl. CPC G07C 9/00111; G06Q 10/0836; G07C 2009/0092; G07C 9/00309; H04N 7/183; G06K 7/1413

(57) ABSTRACT

The present invention relates to a secure method of delivering packages/parcel. The invention has the added advantage of securely delivering the package inside the home or business without the customer's presence at the location. The delivery would occur through a smart access window located either on the entrance door or rooftop of the business or residence. If the access window is located on the rooftop then the package would be delivered by a drone that can send a remote signal to open the access window. An additional feature allows the customer, the vendor, and the courier service to be notified via a mobile device or by email before, during, and after the package is securely placed inside the house or business.

This application claims the benefit of priority from U.S. provisional application No. 62/682,141.

### FIELD OF INVENTION

The invention relates to a secure method of delivering a package and/or mail to a residential or commercial building at any location. It involves the tracking of a package from the time of order to the delivery of the package inside the home or business, to final notification of the delivery of the package to the vendors, courier service and to the customer that placed the order.

### BACKGROUND

Current methods of delivering packages involve delivery through a courier service where the package is picked up by the courier service from the “vendor” and then delivered at the front door of the residential or commercial location. This method has been used for a long time and is a tried and true method of delivery used by courier services such as FEDEX and the US postal service alike. With the advent of the digital age and the emergence of ecommerce, the number of package deliveries has grown exponentially. Likewise, customer's expectation for fast, safe and secure delivery has steadily increased. While the current delivery methods are effective and can be scaled up to meet demands, the methods do not guaranty a timely and secure delivery of a package to the home or business. This is because while the package is tracked from order all the way to the customer address, it is either left outside thus exposing the package to damage due to natural elements such as rain, snow and vandalism etc. Furthermore, the drawbacks include mistaken delivery of valuable packages to the wrong address.

More recent methods of delivering packages includes delivery system where the customer retrieves the packages from the post office. Although secure, this method lacks convenience and involves loss of valuable time to go to the post office to retrieve the package.

Other package delivery systems include the Landport lock box invented by Jody L. Pettit, Mark Annen, and David Lindberg involves a secure box that is placed on the ground in proximity to the door which requires a password made up by the owner and included in the special instructions during the ordering process. The delivery person enters the passcode to open the box and place the purchased item. The customer then retrieves the item using the passcode he/she established during the online ordering process.

Yet another system disclosed in U.S. Pat. No. 5,624,071 A by Folarin O. Sosan, a device is attached to the outside of the door and a combination lock permits the mail carrier to open and deposit packages in the receptacle.

Each of these systems require generating a pass code that is used by the delivery person to open and place the purchased item and for the customer to retrieve the purchased item.

A more recent invention by U.S. Pat. No. 9,898,711 by Thomas Neal (published on Feb. 18, 2018), discloses a computer-based method for shipping and delivering a package which comprises, reserving a deposit terminal for placing a package with a virtual delivery address of a recipient which then is picked up by a carrier; converting, through a central computer system, the virtual address into a postal address; and delivering the package to a destination terminal drop-box corresponding to the postal address; notifying the recipient of the delivery of the package; and unlocking the drop-box after verifying the recipient's identity.

The steps include reserving a terminal for placing a package to be shipped; accessing a terminal for placing the package; securing the package in the terminal; automatically notifying a carrier that the package has been placed in the terminal for pick up and shipment; which is then picked up by the carrier from the terminal and scanned and sends a notification that the carrier has picked up the package from the terminal; computing an estimated time of arrival of the package at a destination; transporting the package to a destination terminal based on a virtual address; securing the package to the destination terminal; and notifying a recipient that the package is available for pick up.

However this method is cumbersome in that it takes more time and requires more steps more coordination as the package requires to be delivered to a terminal and then picked up by a carrier who must acknowledge the arrival of a package and then notify a recipient in order to be picked up the package from a terminal or a drop-box.

The present invention is a simple and secure method of delivering a package and/or mail to a residential or commercial building at any location. The method includes tracking of the package from the time of on-line order to the delivery of the package inside of a residential home or a business, to final notification of the delivery to the vendor(s), the courier service that delivers the package and the customer. No drop-box of any kind of or containers outside the residence or commercial building are required.

In a further embodiment the access window can be on a garage door or on a roof top and the package is delivered by a delivery person or a drone.

This system includes a secure box or receptacle that remains folded on itself and attached to the door from the inside of the house. When a package is ordered, a random barcode or signal is generated and is placed on the package along with the delivery address during the online ordering process. At the same time the barcode or signal information is transmitted to the smart safe door through the internet. The delivery person will present the barcode or signal which is attached to the package to the bar code o signal reader that is located on the outside of the smart safe door. Upon a match between the barcode or signal presented and the signal transmitted to the SSD from the vendor, an outer layer of the door slides open and the inner part of the door (also known as the smart access apparatus) folds to create a box in which a package is placed. Alternatively, upon a match between the barcode or signal presented and the signal transmitted to the SSD from the vendor the SSD opens towards the inside of the residence (through the door or garage door). The current invention involves a smart door controller (SDC) integrated on the inside part of a door and uses a barcode scanner visible from the outside of the door to open a window box for the package to be placed in.

For each side of the box to connect there are hook like structures placed on the bottom of the right side of 1 that fit into each other. This connects each side to each other forming a box like shape.

### SUMMARY

The present invention is particularly valuable to online ecommerce providers because it allows them to track the complete lifecycle of orders, from an online order submission to delivery inside the home or business of a recipient. It will eliminate loss of packages due to vandalism, damage related to weather, and reduces claims of lost packages significantly. It also eliminates disputes arising from such incidents. These litigations due to loss claims cost companies and customers millions of dollars per year in direct and indirect costs.

Against the above drawbacks, there is a clear need for a novel method for a secure delivery that guarantees the final step of the delivery processes, ie., essentially delivering the package inside of the home or business.

The present invention relates to a secure method of delivering packages, to avoid the shortcomings mentioned above. In addition to overcoming the above challenges, the invention has the added advantage of securely delivering the package inside the home or business without the customer's presence at the location. An additional feature allows the customer, the vendor, and the courier service to be notified via a mobile device or by email before, during and after the package is securely placed in the house or business.

### BRIEF DESCRIPTION OF DRAWINGS

FIG. 1: Reference Diagram of major components
This includes the smart safe box, barcode reader, video camera, and the activator . . . this shows the generation of the barcode for the specific item and transmission of the order to the smart box controller on the smart door.

FIG. 2: General Schematic view of process
Starting from the online order to the opening of the smart safe box. Smart box controller begins recording, closing of smart box, notification, and the reset of the barcode data.

FIG. 3: States of Door Closure
The colors indicate the delivery of the item.

FIG. 4: Sample smart box access types
These drawings represent the different possibilities of how the smart box is activated.

FIG. 5: One rendition of the SSB without side panels
5a represents it in natural state.
5b is when it is activated and forms into a containment cavity.

FIG. 6: Another rendition of the SSB with side panels including fitting systems.
6a represents it in natural state.
6b is when it is activated and forms into a containment cavity.

FIG. 7: Rooftop access window in the form of a sliding door (equivalent to SSD).

FIG. 8: Rooftop access window in the form of a trapdoor (equivalent to SSD).

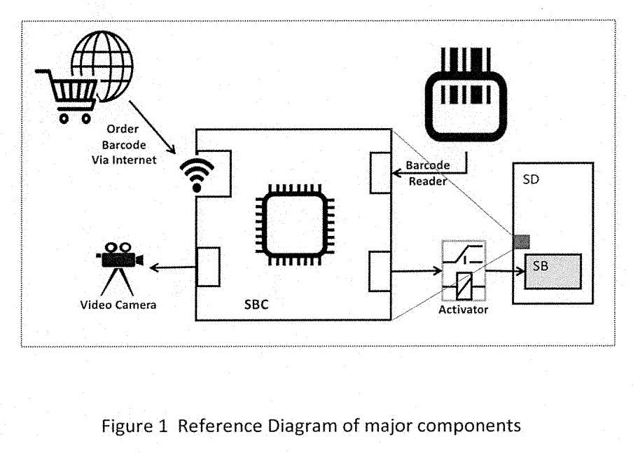

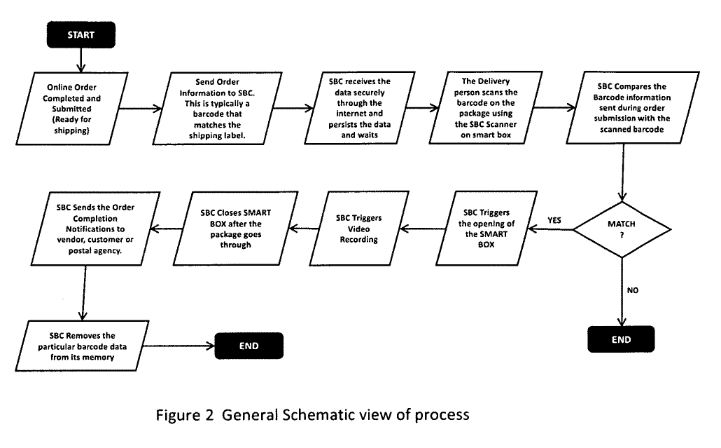

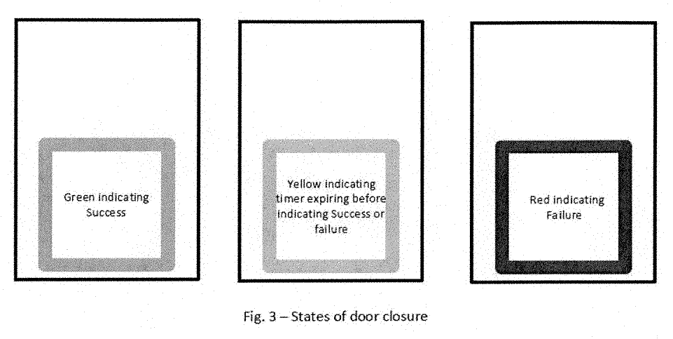

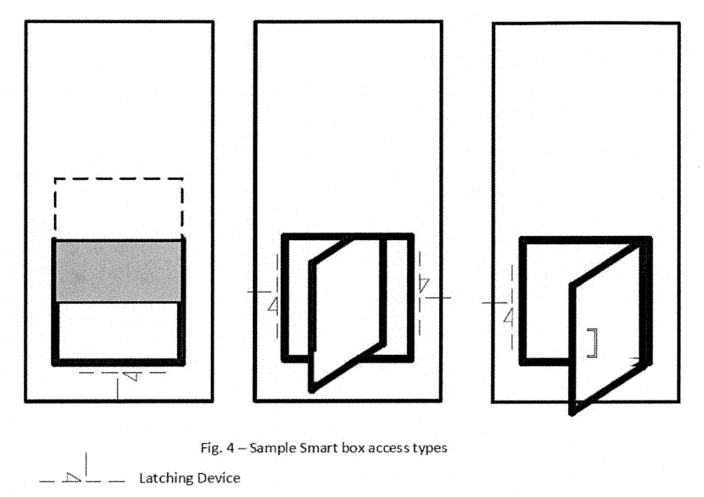

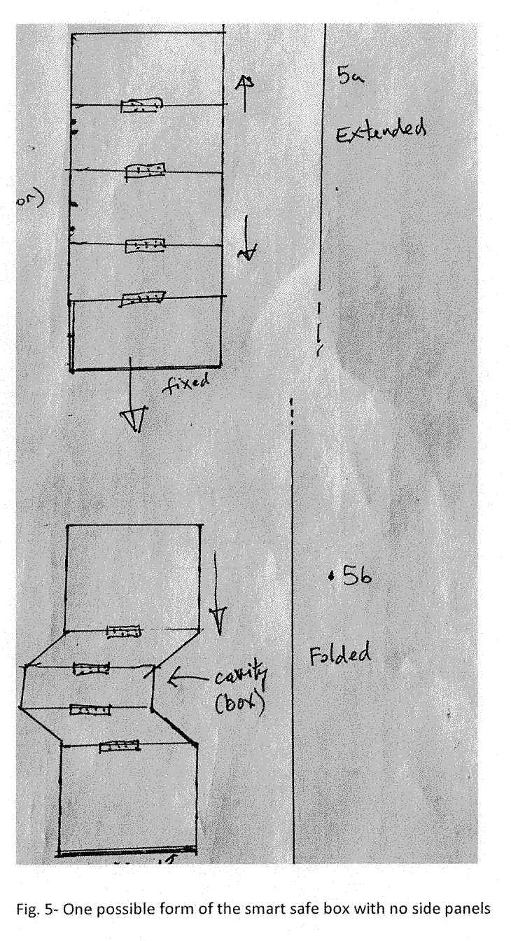

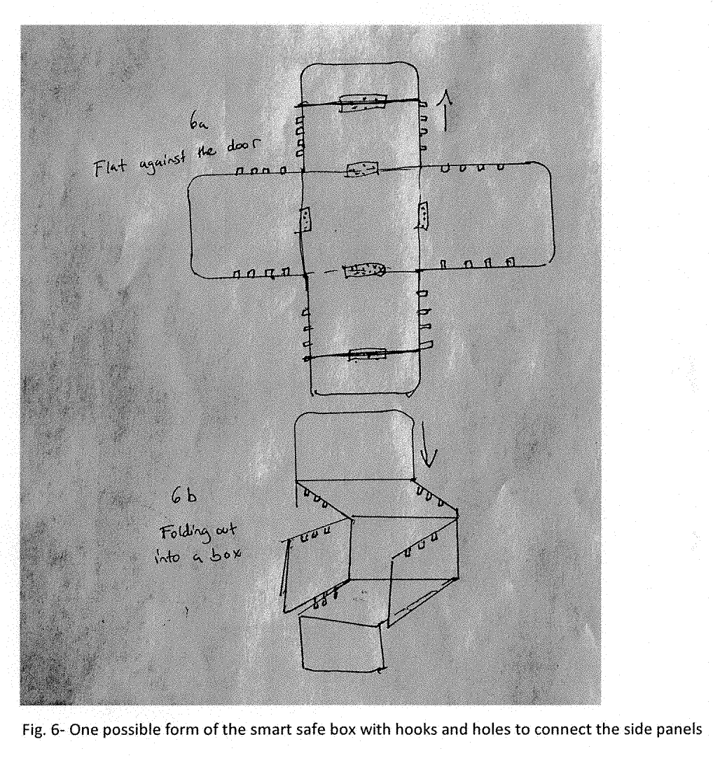

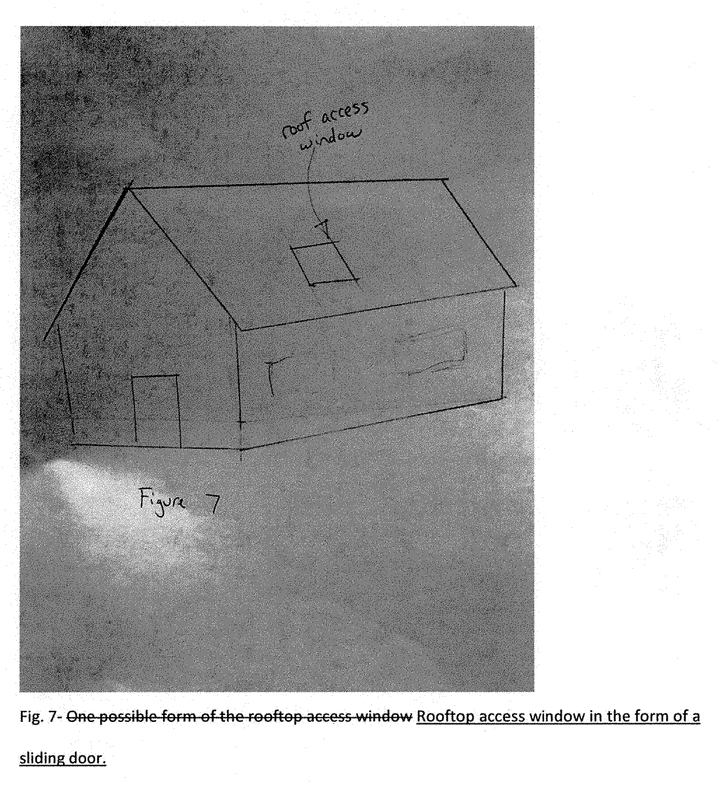

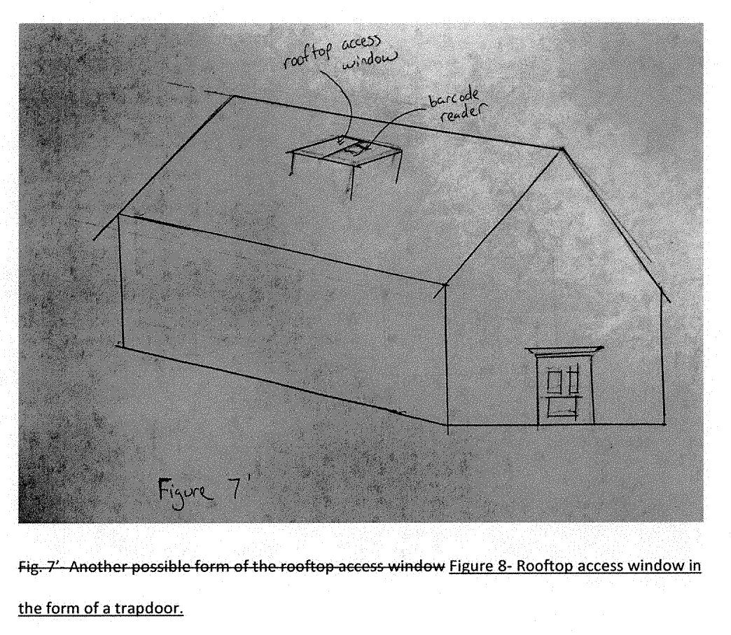

### DEFINITIONS

Smart Safe Door (SSD/SD)—What is implied by “Smart Safe Door” (SSD) is a door that is fitted with a module comprising a barcode reader, an information receiver, an activator, a video camera, and an access window for delivering a package (FIG. 1). This also includes a garage door and roof fitted with access windows.

Smart Safe Box (SSB/SB)—What is implied by “Smart Safe Box” is an access apparatus that is part of the SSD that includes a Smart Box Controller (SBC), a mechanized access door and is integrated with a video control mechanism and sensor instrument (see FIG. 1).

Access window: is an entry way that is responsive to a command from a software application transmitted from a chip placed in the SSD. It can be fitted on a door, a garage door accessible to a delivery person, or on a rooftop accessible to a drone delivery.

Drone: a flying device used to deliver a package and can have the ability to open the access window on a roof top.

Inner face of the SSD: The door as it is seen from inside of the residential home or business.

Smart Box Controller/Smart Safe Door Controller (SBC/SSDC)—SBC or a SSDC is a system that is part of the SSB, which is able to receive multiple inputs and can take actions based on programmed criteria to control other devices. (see FIG. 1). The SBC is an “Internet Of Things” (IOT) device. It has an IP address and is accessible on the internet, and thus has the ability to receive and send messages from/to external systems on the internet. It is able to receive inputs from barcode scanners and sensors. In this invention, the SBC is able to compare barcode information that it received from eCommerce providers with a barcode scanned from a package, in order to control the mechanized access door in the SSB. Some embodiments include other types of identification matches. The SBC has the ability to initiate a security camera system as soon as the barcode is scanned until the package is safely inside the residence or business, at which time it stops recording and saves the feed for a programmable period. The SBC is able to sense the opening and closure of the access door. The SBC has the ability to send notification of the package delivery to the eCommerce provider, the customer, the Courier service provider or to the postal service provider.

eCommerce Providers—These are product vendors that sell products to online shoppers (These transactions can be B2B or B2C). Example of eCommerce providers include Amazon, Walmart, Target, Macys, Home Depot, etc.

B2B—a process for selling products or services to other businesses.

B2C—a process for selling products directly to consumers.

Inside a residence: Implies inside the home of a customer

Inside a commercial building or business: In the interior of a building or a business.

### DETAILED PROCESS DESCRIPTION

I. An online order is initiated by a customer at an eCommerce website that provides an online shopping experience. Many embodiments of online shopping experiences currently exist. The claim of the invention is to use and extend all shopping experiences that exist to have the additional secure delivery feature.
II. At the final stage of the order flow, i.e., after the order is submitted by the customer an order tracking tag comprising or consisting of a barcode label associated with the specific order is generated.
III. The barcode is sent electronically, through the internet, to the Smart Box Controller (SBC).
IV. In another embodiment, the barcode can be supplemented by additional day/time window information.
V. In one embodiment, the barcode information is directly transmitted to the Smart Box Controller (SBC) by the vendor.
VI. In another embodiment the barcode is transmitted to the customer mobile device, who then loads the barcode information onto the SBC.
VII. In yet another embodiment the barcode access can be supplemented with a code provided by the package sender to the courier. Where the code is a supplemental second stage authentication to the barcode
VIII. In the case of e-commerce, upon the customer completing the order, the online vendor initiates the shipping process, where the vendor places the barcode label on the package. The package is picked up and delivered by the courier or postal service to the customer's address, where the delivery person scans the bar code on the package using the SBC barcode reader.
IX. The SBC compares the barcode with the one it received from the eCommerce vendor or customer and verifies match. Note in some embodiments, the matching can be performed within the day/time window sent from the eCommerce provider/vendor only. Note in other embodiments, the courier has to enter an additional code for authentication/match to be complete
X. An embodiment of the solution includes a method where the SBC system is integrated with a video camera system that captures the package transition and can automatically send information to the customer, the courier service and the vendor.
XI. Upon a match, the SBC would open a locking mechanism in the Smart Box giving access for the product to be placed inside the house. The type of access can vary from a hatch and lock mechanism, sliding door, doors that can pivot in the center and swing doors (See FIG. 4) where the door can be a front door, a garage door or a roof access equipped with a SBC.
XII. In some embodiments, the smart box further would implement a mechanism to indicate the closed and open positions of the smart box, an embodiment of this would have an LED light surrounding the Smart Box. A green light indicating success of opening and/or closing. An amber light would indicate that the smart box is open, and a timer has kicked in for placement of package into the house while a red light would indicate a failure of closure or an expiry of time estimated to place package into the house (See FIG. 3)
XIII. In another embodiment, after smart box is opened, the SBC can include a detector that monitors the transition of the package. When the detector determines that the package is in the house, it re-locks the package door on the Smart Box.
XIV. The Smart Box is designed for maximum access through a standard door for delivering packages. Different implementations of doors would give different size of packages to be delivered inside the house. The smart box also takes into account delivery of the product without damage to the delivery package.
XV. The SBC would close the locking mechanism to be actuated in the Smart Box after the product is inside the house.
XVI. The SBC then automatically sends notification to the vendor, customer and courier service.
XVII. If locking has not been triggered successfully and the timer expired, the customer, courier, and package sender shall also be notified
XVIII. Once the SBC detects that the package is in the house, and sends notifications, the SBC proceeds with removing the barcode sent by the vendor from the list of barcodes in its database. See FIG. 2 for an example of the schematic view of the process
XIX. Some embodiments include notifications sent at various stages of the process. In some embodiments sending notifications can precede opening the smart box.
XX. An embodiment can include sending notifications and waiting for further instruction before opening the smart box.
XXI. The locking mechanisms for the SB can have many current embodiments.
XXII. The mechanized smart box opening system can have many current embodiments.
XXIII. The security video recording feed can be integrated to current embodiments.

FIG. 1 is a reference diagram that shows the system components included in this embodiment. FIG. 2 is a reference diagram that shows the solution process.

Note that present invention extends beyond the specific description of the process from those disclosed herein to other alternative process embodiments. Thus, the scope of the claims by the present invention is not limited by any of the particular embodiments described.

Although preferred embodiments of the present invention have been shown and in these embodiments without departing from the principle and spirit of the invention, the scope of which is defined in the appended claims and their equivalents.

1. A smart safe door (SSD) that is used for secure delivery of a package in the interior of a residential home or business location where the smart safe door comprises:
i) A control module comprising a barcode reader that receives and transmits a signal to an access window where the access window is on a front door, on a garage door or on a roof of the residence or the commercial building.
ii) The access window that opens and/or closes in response to a signal from the barcode reader through an activator to receive a package.
iii) A video camera that simultaneously records the package delivery.

2. The smart safe door according to claim 1 where the access window can have variable dimension and/or shape for delivery of a package.

3. The smart safe door according to claim 1 where the access window can be on a front entrance door or a garage door or roof access of a residential house or commercial building.

4. The smart safe door according to claim 3 where the access window can be on the front door of a residence, on a garage door of a residence, front door of a business entity, or a roof access.

5. The smart safe door of claim 2 where the shape can be square, rectangular, circular, pentagonal or any shape.

6. The smart safe door according to claim 1 where the access window can have a dimension of 12×12, 15′×10′ or 15′×12 or 15′×15′, 22′×12′, 22′×15′ or 22′×22′ or larger.

7. The smart safe door according to claim 1 where the access window is on the roof and the delivery is done by a drone.

8. The smart safe door according to claim 1 where the access window can be any one of the options in FIG. 4(a)-4(c).

9. The smart safe door according to claim 1 where the inner face of the SSD can be fitted with a module to accommodate a package according to FIGS. 5(a) and 5(b) or FIGS. 6(a) and 6(b).

10. A software application that allows successful transmission of the barcode information generated by a vendor or a third party to the barcode reader module on the smart safe door according to claim 1.

11. The software application according to claim 10 that allows successful transmission of the barcode information generated by a vendor to the customer's mobile device.

12. The software application according to claim 11 where the barcode information persists the data until it is activated by the smart safe controller.

13. The software application according to claim 11 where the application is used for online purchase.

14. The software of claim 11 where the information is optionally sent from the vendor to the customer and the customer sends it to the access window on the smart safe door.

15. The software according to claim 10 where the SBC compares the barcode it has received from the vendor to the barcode on the package and upon matching, the activator opens the smart safe box to give access for the package inside the residence or commercial building.

16. A method of securely delivering a package, mail, or grocery inside a residential or commercial location from the time of an online or telephonic order until the package, mail, or grocery is inside the residence, office, or commercial location where the method comprises
Customer makes an online order or a telephonic order
The vendor places a tracking tag comprising or consisting of a barcode label associated with the specific order to the specific address on the package
The barcode info is automatically sent through the internet to the barcode reader fitted on the SSD, window, garage door, or rooftop.
The package is picked up and delivered by the courier or postal service to the customer's address where the delivery person scans the bar code on the barcode reader/scanner placed on the door thereby opening the access window through which the package can be delivered.

17. The method of claim 16 where the access is a sliding door (FIG. 4a), a pivoting/swinging door (FIG. 4b), a hatch and lock mechanism (FIG. 4c), and an opening of any shape.

18. The method of claim 16 where the access leads to the interior of the residence or business.

19. The method of claim 16 where the access leads to a folding unit at the inner face of the door and forms into a box of any shape.

20. The method of claim 19 where the folding unit is activated to produce a box by forming a cavity towards the inside of the house or business when the SBC opens the front access window.

21. The method of claim 16 where the package can be dropped inside a house or business by a drone where the drone uses a remote access code to open an access window on the rooftop.

22. The method of claim 16 where a video camera integrated with the SBC that captures the package transition and automatically sends the information to the customer, courier service, and/or data center of the vendor.
